(19) United States
(12) Patent Application Publication
(10) Pub. No.: US 2026/0172428 A1
(43) Pub. Date: Jun. 18, 2026

(54) METHOD FOR PROCESSING A REQUEST TO EXECUTE A SERVICE IN A COMMUNICATION NETWORK, AND CORRESPONDING METHOD FOR VALIDATING THE REQUEST, INTERMEDIATE ENTITY, VALIDATING ENTITY, SYSTEM AND COMPUTER PROGRAM

(71) Applicant: ORANGE, Issy-les-Moulineaux (FR)

(72) Inventors: Michel TREFCON, Châtillon (FR); Alexandra ANSIAUX, Châtillon (FR)

(21) Appl. No.: 19/121,943

(22) PCT Filed: Oct. 19, 2023
(86) PCT No.: PCT/EP2023/079144

§ 371 Date: Apr. 17, 2025

(30) Foreign Application Priority Data
Oct. 21, 2022 (FR) FR2210911

(51) Int. Cl. H04L 9/40

(52) U.S. Cl. CPC H04L 63/123

(57) ABSTRACT

A method for processing a request to execute a service in a communication network, from a service consuming entity to a service executing entity. The method is implemented at an intermediate entity configured to receive messages from the service consuming entity intended for the service executing entity or from the service executing entity intended for the service consuming entity. The method includes: receiving the request to execute the service from the service consuming entity; deciding whether or not to transmit the request to execute the service to a validating entity for validation of the request, which validating entity is separate from the service executing entity, before transmitting the request to the service executing entity.

### FIELD OF THE INVENTION

The field of the invention is that of a communication network, in particular a communication network implementing a service-oriented architecture based on network functions.

In such a network, the invention relates in particular to the validation of a request to execute a service before transmitting it to the service executing entity.

### PRIOR ART

The 5G core network consists of multiple network functions NF, each with its own role and logic. An NF is generally responsible for executing several services. Each service has its own role and logic within its NF. In order for one service to communicate with another, each service is accessible as an application programming interface or API.

The 3GPP standardisation body specifies the API of each of the services implemented by the network functions NF it has defined for the 5G core network, in a document written in a dedicated description language (OpenAPI Release 3). This document describes among other things the operations supported by the service and the format of the data structures exchanged. These data structures are a set of attributes, each attribute being characterised by a simple type (character string, number, Boolean, etc.) or the type of a structure, a name and authorised values. If necessary, it can specify constraints applicable to attributes or groups of attributes. The 3GPP further specifies that any request to execute an operation of the service that does not comply with the format of the API of this service must be rejected by the solicited service, and provides for various error messages to be returned to the entity that sent the request.

Indeed, the processing by a given service of requests to execute operations that do not comply with the API of this service may lead to malfunctions, with undetermined consequences for the operation of the service itself, of the network function NF that hosts the service or even of the core network. It should be noted in this respect that the sending of an invalid request to execute an operation (that is, that does not comply with the API) may be intentional or unintentional, for example due to a bug in a computer program. Given the fact that the 5G core network in its first version (version 15) already includes more than 50 services, it is understandable that the multiplication of these malfunctions could have an impact not only on the quality of service, but also on the overall security of the core network.

Nowadays, a validity check of the requests to execute a service or an operation of a service is performed by the entity responsible for executing the service. Thus, the network functions NF of the core network, and thereby the entity responsible for executing a service of this network function, are typically software entities, comprising a request validation layer and a service execution layer. However, the executable file of a service generally inseparably comprises the service business logic and the operation validity check. As a result, as soon as a change occurs for the execution of the service, the entire software must be updated and retested, even if the operation validation part is not affected by this change.

However, the network functions NF of the core network are software entities (that is, software) that can be designed using computer languages from various frameworks. The choice of these software technologies rests with the service designers and with the manufacturers of the server devices that host these services. It is made based on the suitability of the characteristics of the service to be designed and the software technologies mastered by their research and development teams. Current software ecosystems are indeed many and varied, and mastering all of these ecosystems requires significant investment for a manufacturer. It will also be understood that the most appropriate software ecosystem for designing a service is not necessarily the one that provides the best level of control over the validity of an operation executed by that service.

In addition, the programming interfaces APIs of the 5G core network services are complex and evolve regularly at the rate of several publications per year. Consequently, the development of an operation validation software layer, depending on the one hand on the 3GPP release of the service in question and on the other hand on the software ecosystem of a software layer for executing this service, is a task that must be repeated frequently by programmers and in a non-optimal programming environment, requiring significant investment for a high risk of bugs and regressions.

Finally, tools are known for automatically generating computer code for the validation layer from OpenAPI description documents of an API for a service of a given network function NF of the 5G core network. One advantage of these tools is that they are capable of producing new computer code of the validation layer for any new service as well as for a new 3GPP release of an existing service. Compared with a design performed by a programmer, the quality of the produced code is higher (lower risk of bugs and regressions). However, as the OpenAPI format for describing the APIs of the core network also evolves with each successive release, the tools for automatically generating computer code must evolve too.

There is therefore a need for a solution for validating the requests to execute a service that is both more efficient and easier to implement and maintain. The invention improves the situation.

### SUMMARY OF THE INVENTION

The invention responds to this need by proposing a method for processing a request to execute a service in a communication network, from an entity referred to as a service consuming entity to an executing entity of said service, said method being implemented at an intermediate entity configured to receive messages from the service consuming entity intended for the service executing entity or from the service executing entity intended for the service consuming entity, and comprising:
receiving said request to execute the service from the service consuming entity;
deciding whether or not to transmit for validation the request to execute the service to a validating entity of said request, distinct from the service executing entity, before transmitting said request to the service executing entity.

The invention thus proposes a completely new and inventive approach to the processing of a request to execute a service operated by a communication network, that consists on the one hand in separating the prior validation of the request to execute the service itself and on the other hand in entrusting the processing of these requests and their routing to one and/or other of the validating and service executing entities, to an intermediate entity positioned at a cut-off point of the service execution requests sent by consuming entities in the communication network and at the front end of the validating and service executing entities.

For example, according to the invention, these functions for validating the requests and executing the service are performed by distinct entities of the communication network. In this way, each of them can be designed in the framework considered the most suitable by the designer/manufacturer. The invention also makes it possible to use a single framework to design the entities for validating requests to execute several distinct services, regardless of the API associated with them and the framework used to develop the corresponding service executing entity. Thanks to the invention, a player in the field can therefore specialise in the design of entities/components for validating API operations of network function services of a communications network. With the invention, the intermediate entity controls the processing of the requests and their potential prior validation. Because of its position at a cut-off point of the request flow between client entities (consuming a service) and server entities (producing/executing the services), it has visibility over all the transactions relating to the services in question and has information to decide whether or not it is necessary for a received request to be subject to prior validation, which notably enables an adaptation to an operating context, such as a saturation state of the network, a level of quality of received requests based on the service requested, etc. It can implement, if necessary, systematic validation of all the requests it receives or, on the contrary, choose to subject only some of the requests to prior validation based on information it has about the operating state of the communication network, such as the traffic status, the quality level of the previously received requests, etc.

The invention thus offers great flexibility, while still meeting the required quality criteria. It also allows the chosen validation policy to evolve over time.

The invention also makes it possible to increase the modularity of a communication network.

It also allows to optimise and streamline the investment efforts of a software solution developer for validating service execution requests in a context of heterogeneous software ecosystems.

It is particularly suitable for a communication network, such as the 5G core network, implementing a virtualised and distributed cloud computing architecture of network functions, that promotes the sharing, via networks, of resources that provide access to an infrastructure, services, platforms and on-demand applications.

In such an architecture, the physical or hardware resources, for example server devices with significant computing and memory capacities, are used by an orchestrator that supervises in real time the allocation of memory and computing quotas, referred to as virtual machines or containerisation instances, to software entities of the network function NF type, services of these network functions NF or even operations of these services, monitors the amount of memory and computing time or CPU (Central Processing Unit) actually used by each entity and replicates/deletes the virtual machine or containerisation instances of a given software entity to meet increased/decreased needs.

For example, the service required by the service consuming entity is implemented in a given network function. Such a network function consists of entities organised together in a network and that cannot be reached/routed directly from the outside. It is understood that these entities (and the associated network function) form a sort of sub-network of which the service consuming entity generally only knows a public identifier, for example a URL. This network function can provide one or more services.

The intermediate entity thus acts as a gateway between the service consuming entity, that requests the execution of this service, and the executing (or producing) entity of the requested service. It can be for example a reverse proxy device that hides from the service consuming entity the presence of the entities belonging to the network function and contributing to the execution of the requested service.

The invention is therefore in line with the trend towards disaggregation or decomposition of the 5G core network logic.

Advantageously, the invention is implemented at an intermediate entity positioned at a cut-off point (at the front end) of the network path taken by the requests to execute a service and configured to transmit the requests to be validated to a validating entity distinct from the service executing entity.

According to another aspect of the invention, the method comprises:
transmitting said request to execute the service to the service validating entity;
receiving at least one response message from among a validation information message and an execution report message; and
transmitting the received response message to the concerned entity from among the service consuming entity and the service executing entity, based on the received response message.

One advantage is that the intermediate entity integrates the required intelligence to transmit the request and/or response messages it receives to the appropriate entity. In addition, its role and position give it visibility over the quality of requests, which enables it to decide whether or not to suspend the systematic validation of the next requests to be processed.

The invention thus makes it possible to implement at least two embodiments:
according to a first embodiment, the validating entity and the service executing entity do not communicate directly with each other. The intermediate entity is a mandatory passage for messages between the validating entity and the service executing entity. According to this embodiment, the intermediate entity receives the validation information message from the service validating entity. If the request is not validated, this validation information message comprises a message body describing the cause of the rejection and a status code. For example, a response message that complies with the 3GPP specifications comprises a class 4xx HTTP status code. When the request has been validated, the information message comprises a status code that indicates to which entity the request should be transmitted, which should be considered as validation of the request. In the embodiment described here, this status code is a class 3xx HTTP code.

Consequently, the intermediate entity always receives at least the validation information message and, where applicable, the execution report;
according to a second embodiment according to the invention, the validating entity and the service executing entity do not communicate directly with each other. In the event of positive validation, the validating entity transmits the request to execute the service directly to the executing entity and receives in return the execution report it transmits to the intermediate entity. If the request is not validated, the validating entity sends a validation information message to the intermediate entity. Consequently, the intermediate entity always receives at least either a negative validation message or an execution report;

According to yet another aspect of the invention, the at least one received response message comprises a validation information message from the validating entity comprising a validation result, the validation information message is transmitted to the service consuming entity when the validation result is negative, and the request to execute the service is transmitted to the service executing entity when the validation result is positive.

According to this first embodiment, the intermediate entity is also a mandatory passage between the validating entity and the service executing entity, which do not communicate directly with each other. This configuration is particularly suitable in the case where they do not belong to the same subnet or the same network function.

The service consuming entity receives a validation error message and the request is not transmitted to the service executing entity. One advantage is that the service consuming entity is informed that the request to execute the service is rejected because it is not valid.

According to yet another aspect of the invention, the method comprises, in response to a positive validation result, the obtaining by the intermediate entity of an identifier of the service executing entity, and the request to execute the service is transmitted to the service executing entity using said obtained identifier.

One advantage is that the identifier enabling access to the service executing entity is obtained by the intermediate entity only in the event of successful validation. It is thus ensured that the service executing entity only processes valid requests. This identifier can be private, when the service executing entity is comprised in a network function or a sub-network of another type, and public otherwise, so that the service executing entity can be reached directly. The service execution identifier can be obtained by the intermediate entity from the validation information message received from the validating entity (for example, it is contained in this message), or as a variant be determined by the intermediate entity.

According to yet another aspect, said at least one received response message comprises a service execution report message sent by the service executing entity and said service execution report message is transmitted to the service consuming entity.

Advantageously, when the request has been validated, the intermediate entity receives in all cases (whether or not the validating entity is connected to the service executing entity) an execution report message comprising a result or at least a confirmation of the execution of the service from the service executing entity, that it transmits to the service consuming entity.

According to another aspect of the invention, the decision to transmit or not said request to the service validating entity is made based on at least one given decision criterion relating to at least one network operation indicator and/or one type of request to execute the service.

For example, said at least one network operating indicator belongs to a group of indicators of an operating state of the network, comprising at least one indicator of traffic, latency, occupancy (saturation) of the physical resources of the network over a given time period, a quality indicator of the service execution requests such as a rate of requests not validated by the validating entity during the given time period, a rate of error messages generated by the service executing entity for requests that have not been subject to prior validation, etc. It can also be a counter of service execution requests previously submitted for validation during an elapsed time period. For example, a request is transmitted directly every ten requests submitted for validation. As for the decision criterion, it comprises a threshold value of said at least one indicator.

As a variant, the criterion for deciding whether or not to transmit the request to the validating entity can be considered to be related to a type of service execution request (for example, depending on whether these requests concern the creation, modification, deletion or consultation of a resource).

In this way, the invention makes it possible to achieve a compromise between the effort put into validating the requests to execute a service and preserving network resources.

The invention also relates to an intermediate entity of a communication network, configured to receive messages from an entity, referred to as service consuming, to an executing entity of said service and to receive messages from the service executing entity intended for the service consuming entity, and configured to implement:
receiving a request to execute the service from the service consuming entity;
deciding whether or not to transmit for validation the request to execute the service to a validating entity of said request, distinct from the service executing entity, before transmitting said request to the service executing entity.

Advantageously, said intermediate entity is configured to implement the steps of the method for processing a request as previously described.

Correlatively, the invention also relates to a method for validating a request to execute a service in a communication network, said request having been sent by an entity referred to as a service consuming entity of said network to a service executing entity, said method being implemented at a service validating entity distinct from said executing entity, and comprising:
receiving said request to execute the service from an intermediate entity configured to receive messages to or from the service executing entity;
checking a validity of said request to execute the service, comprising obtaining of a validation result; and
executing at least one action based on the validation result obtained.

With the invention, request validation is therefore performed by an entity distinct from the service executing entity. This independent entity receives the requests to be validated from the intermediate entity. It can therefore be designed in a framework different from that of the execution entity. It can also be pooled for several services.

According to one aspect of the invention, said at least one action comprises transmitting a validation information message comprising the validation result to the intermediate entity.

One advantage is that the responsibility for deciding whether a request to execute a service should be transmitted or not to the service executing entity is entirely entrusted to the intermediate entity. The only responsibility of the validating entity is to validate the service execution requests it receives from this intermediate entity and to return to it a validation result.

According to a particular embodiment, a positive validation response can further comprise an identifier of the service executing entity.

This identifier enables the intermediate entity to transmit to the service executing entity the request to execute the service. One advantage is that it is obtained by the intermediate entity only when the execution request has been considered valid by the service validating entity.

According to another aspect of the invention, when the validation result is positive, said at least one action comprises transmitting said request to execute the service to the service executing entity.

One advantage is that the validating entity directly redirects a service execution request considered valid to the concerned service executing entity. In this way, the latency introduced by the validation phase is reduced to a minimum.

According to yet another aspect of the invention, said at least one action further comprises receiving a response message from the service executing entity comprising a service execution report and transmitting said response message to the intermediate entity.

The invention also relates to a validating entity of a request to execute a service in a communication network, said request having been sent by a service consuming entity to a service executing entity. The validating entity is configured to implement:
receiving said execution request, said request having been transmitted to the validating entity by an intermediate entity configured to receive messages from an entity, referred to as service consuming, to an executing entity of said service and to receive messages from the service executing entity intended for the service consuming entity;
checking a validity of said request; and
transmitting a response message to the intermediate entity comprising at least a validation result.

Advantageously, said validating entity is configured to implement the steps of the method for validating a request as previously described.

Advantageously, said intermediary entity and said validating entity are comprised in a system for managing a service in a communication network, said system comprising a service consuming entity and a service executing entity, said consuming entity being configured to transmit a request to execute the service to the service executing entity.

The system has at least the same advantages as those provided by the above-mentioned processing method and validation method.

The invention also relates to computer program products comprising program code instructions for implementing processing and validation methods as described previously, when they are executed by a processor.

A program can use any programming language, and can be in the form of source code, object code, or intermediate code between source code and object code, such as in a partially compiled form, or in any other desirable form.

The invention also relates to a computer-readable storage medium on which are saved the computer programs comprising program code instructions for implementing the steps of the methods according to the invention as described above.

Such a storage medium can be any entity or device able to store the program. For example, the medium can comprise a storage means, such as a ROM, for example a CD-ROM or a microelectronic circuit ROM, or a magnetic recording means, for example a mobile medium (memory card) or a hard disk or SSD.

On the other hand, such a storage medium can be a transmissible medium such as an electrical or optical signal, that can be carried via an electrical or optical cable, by radio or by other means, so that the computer program contained therein can be executed remotely. The program according to the invention can be downloaded in particular on a network, for example the Internet network.

Alternatively, the storage medium can be an integrated circuit in which the program is embedded, the circuit being adapted to execute or to be used in the execution of the above-mentioned method.

According to one embodiment, the present technique is implemented using software and/or hardware components. In this context, the term “module” may be used in this document to refer to a software component, a hardware component or a combination of hardware and software components.

A software component is one or more computer programs, one or more subroutines of a program, or more generally any element of a program or software capable of implementing a function or set of functions, as described below for the module concerned. Such a software component is executed by a data processor of a physical entity (terminal, server, gateway, set-top-box, router, etc.) and is able to access the hardware resources of this physical entity (memories, recording media, communication buses, electronic input/output cards, user interfaces, etc.). Hereafter, resources are understood to be any set of hardware and/or software elements that support a function or a service, whether individually or in combination.

In the same way, a hardware component is any element of a hardware assembly capable of implementing a function or set of functions, as described below for the module concerned. It may be a programmable hardware component or a component with an embedded processor for executing software, for example, an integrated circuit, a smart card, a memory card, an electronic card for executing firmware, etc.

Each component of the system described above naturally implements its own software modules.

The various embodiments mentioned above can be combined with each other for the implementation of the present technique.

### BRIEF DESCRIPTION OF THE DRAWINGS

Other features and advantages of the present invention will emerge from the description below, with reference to the appended drawings that illustrate a non-limiting embodiment. In figures:

FIG. 1 diagrammatically illustrates an example of the architecture of a system for managing a request to execute a service in a communication network according to one embodiment of the invention;

FIG. 2 describes in the form of a flowchart the steps of a method for processing such a request to execute a service, according to the invention;

FIG. 3A describes in the form of a flowchart the steps of a method for validating such a request to execute a service, according to a first embodiment of the invention;

FIG. 3B describes in the form of a flowchart the steps of a method for validating such a request to execute a service, according to a second embodiment of the invention;

FIG. 3C describes in the form of a flowchart the steps of a method for validating such a request to execute a service, according to a third embodiment of the invention;

FIG. 4 FIG. 5 FIG. 6 FIG. 7 FIG. 8 FIG. 9 diagrammatically illustrate the messages exchanged between the various entities of the system for managing a request to execute a service according to a first embodiment of the invention;

FIG. 10 FIG. 11 FIG. 12 diagrammatically illustrate the messages exchanged between various entities of the system for managing a request to execute a service according to a second embodiment of the invention;

FIG. 13 diagrammatically illustrates an example of the hardware structure of an intermediate entity configured to process a request to execute a service according to one embodiment of the invention; and

FIG. 14 diagrammatically illustrates an example of the hardware structure of a validating entity of a request to execute a service according to one embodiment of the invention;

### DESCRIPTION OF THE INVENTION

The general principle of the invention consists in separating, in a communication network, the validation of the requests to execute a service from a service consuming entity, from the actual execution of this service, and at the same time centralising the processing of such requests at an intermediate entity. This intermediate entity is advantageously positioned at the front end of the service consuming entity and the requests it sends, in relation to the entities validating and executing the concerned service. In other words, this intermediate entity is the first entity that receives a request from a consuming entity, i.e., that is visible to that consuming entity. It is therefore positioned at a cut-off point of the flows of requests sent from the consuming entities to the executing entity. As a result, it hides the validating and executing entities from the service consuming entities.

More specifically, the invention proposes to entrust the tasks of validating a request to execute a service and executing this request to two distinct entities of the network placed under the responsibility of the same intermediate entity that controls them. These two entities are, for example, two software entities that may, as a result, have been designed in distinct frameworks and using different programming languages. According to the invention, these two entities have distinct locations (they are typically represented by two distinct executable files) and each has its own identifier, for example of the URI (Universal Resource Identifier) type, which enables another entity of the network to reach it and communicate with it.

The invention thus makes the communication network more modular, and thereby streamlines the design efforts and therefore the investments required to implement efficient validation of the requests to execute services in a communication network. Indeed, since the task of validating a request to execute a service is dissociated from the execution of the service itself, the constraint of adapting to the software environment of the service executing entity is released and a validation solution developer can choose the most suitable framework.

The invention also controls the processing of these requests and their prior validation by this intermediate entity, that has visibility over the request flows, receives information representative of a state of operation of the network and a quality level of received service execution requests and can decide accordingly whether or not to trigger the validation of a new request based on this information. One advantage is to limit a latency and a resource consumption induced by the validation of operations while effectively ensuring an acceptable compliance rate of the execution requests by the service executing entity. In this way, the invention contributes to improving the load management and, more generally, the quality of service within this network.

The invention relates to any type of network implementing a service-oriented architecture (service requester/service provider) based on application devices. In the remainder of the description, the case of network functions NF configured to perform one or more tasks or services and exchange information with each other via a service based interface SBI is considered in particular. However, the invention also applies to other types of application devices, such as Web service application devices.

In a service-oriented, virtualised and distributed architecture, the allocation of physical resources for the implementation of these network functions is supervised by an orchestrator device.

The services are exposed, for example, using standard protocols to represent their data (SOAP, Thrift, JSON) in a serialised manner (i.e. as a string), making it possible to impose the format of the messages exchanged.

Each application device incorporates, for example, a software component designed to perform one or more specific tasks such as retrieving information (for example: the identity of a mobile terminal when it is attached) or executing an operation (for example: implementing a tunnel). By way of example, a network function contains the software code and data required to realise the list of tasks or services associated with this function.

Such services are accessed via application programming interfaces or APIs, for example of the REST (REpresentational State Transfer) API type, configured to execute a service or an operation of a service in response to requests from consuming entities whose validity the designer wants to check.

An example of a network for which the invention is particularly suitable is a 5G core network, as specified by the 3GPP standard.

In the case of the 5G standard, the data format is the JSON format and the exchange protocol is the HTTP/2 protocol. Each service retrieves, creates, modifies or deletes a resource. The POST or PUT or yet DELETE commands are used for writing, while the GET command is used for reading.

Naturally, the invention is applicable to other data formats, to other protocols (the HTTP/3 protocol, for example), as well as in other contexts (a 6G core network, for example).

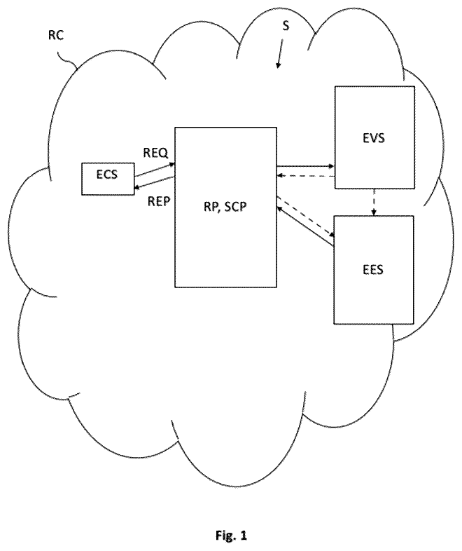

FIG. 1 diagrammatically illustrates an example of the architecture of a system S for managing a request to execute a service in a communication network RC, for example a 5G core network as specified by the 3GPP.

The network RC comprises an entity ECS consuming a service provided by the network RC. It is a hardware and/or software element of the network RC, configured to execute one or more tasks in the network RC and that, to do this, calls this service. For simplicity, only one entity ECS is shown in FIG. 1, but it is understood that the network RC can comprise several of them. It can be for example a particular network function NF that requires the execution of a service of an entity EES producing or executing this service, for example another function NF of this network. It is also understood that a network function can both produce a service for another network function and in turn consume a service provided by this other network function.

The network RC further comprises a validating entity EVS of a request to execute the service provided by the executing entity EES. According to the invention, it is an entity distinct from the executing entity EES. It is configured to validate in particular a format (for example, a name and/or a value) of the data specified in the execution request. This data comprises attributes and parameters included in the body of the request and/or in one or more headers of this request (for example, the unique identifier or URI).

According to this embodiment of the invention, the system S thus comprises the consuming entity of a service ECS, the service executing entity EES and the validating entity EVS of the request to execute the service sent by the consuming entity ECS. The system S further comprises an intermediate entity of the communication network RC, positioned at the front end of the service consuming entity ECS in relation to the service executing entity EES. It can be for example a proxy device, that is configured to receive messages from and/or intended for the service executing entity EES and acts as a gateway between the service consuming entity and the service executing entity, by transforming a public identifier of this service known to the service consuming entity and indicated in its request into another identifier of the service executing entity, not known to the service consuming entity.

According to the invention, the intermediate entity is configured to receive said request to execute the service from the service consuming entity, decide whether or not to transmit the request to execute the service to a validating entity EVS of said request, distinct from the service executing entity EES, for validation, before transmitting (27) said request to the service executing entity EES.

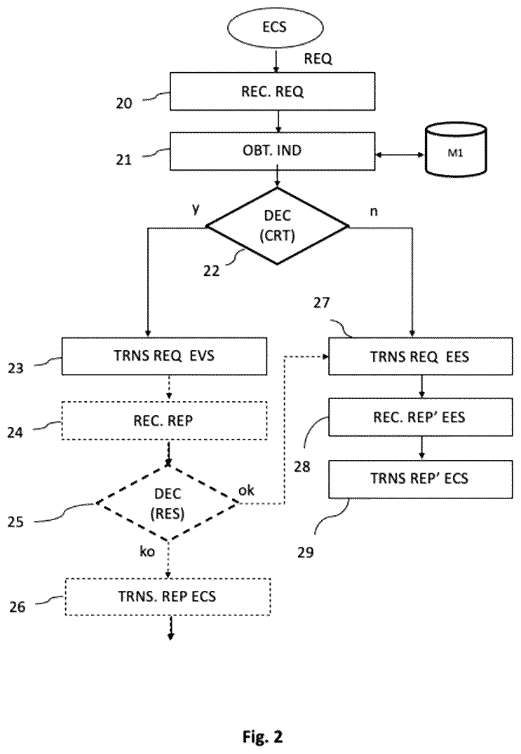

Said intermediate entity thus implements the method for processing a request to execute a service according to the invention that will be detailed hereafter in relation to FIG. 2.

For example, the service executing entity EES is comprised in a subnetwork or private network (not shown) of this network RC, for example that of a network function NF responsible for executing this service. The intermediate entity may or may not be part of the private network and is therefore used to hide the various entities belonging to the private network from the other entities of the network RC. Conversely, the entities of this private network only communicate with the rest of the network RC via this intermediate entity. Thus, the service consuming entity ECS sends its request REQ to an identifier (for example a URI) associated with the service executing entity EES in the network RC or with the network function that implements this service and that it may or may not have previously discovered, and the intermediate entity, that receives this request REQ, then transmits it to a private identifier of this service executing entity or of another entity in the private network to which it belongs. According to a first embodiment of the invention, the intermediate entity is a “reverse proxy” device, as it replaces a “public” identifier with a private identifier, unlike conventional intermediate devices. In the case of a 5G core network, this proxy device processes requests that comply with the HTTP2 protocol. According to another embodiment of the invention, the intermediate entity is of the SCP (Service Communication Proxy) type. This is another type of proxy device, defined in particular in 3GPP Release 16, that provides a single entry point for a group of network functions NF. It is therefore external to these network functions. It also processes requests that comply with the HTTP2 protocol. It should be noted that in this case, the identifier used by this SCP proxy device is a routable, therefore public, address.

According to the embodiment of FIG. 1, the system S for managing a request to execute a service further comprises the validating entity EVS configured to receive said request to execute the service from the intermediate entity RP, SCP, check a validity of said request to execute the service, comprising obtaining a validation result, and execute at least one action for processing the request based on the validation result obtained.

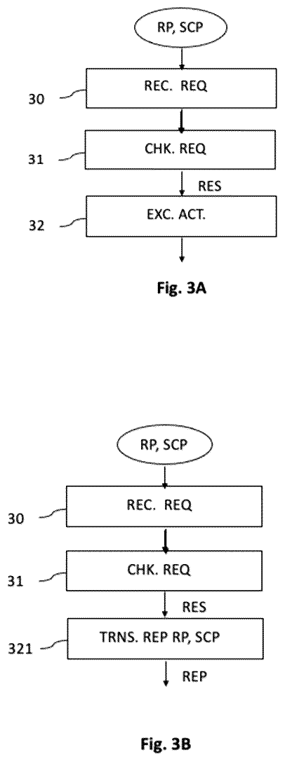

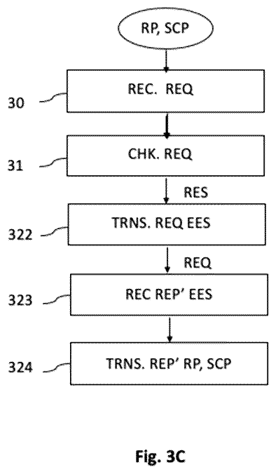

The validating entity EVS thus implements the method for validating a validation request according to the invention, that will be detailed below in relation to FIGS. 3A to 3C.

In relation to FIG. 2, an embodiment of a method for processing a request to execute a service in a communication network RC according to one embodiment the invention is now presented in the form of a flowchart. Advantageously, the method is implemented by the intermediate entity RP, SCP.

In 20, a request to execute a service Si is received from a consuming entity ECS, for example a first network function of the network RC. It should be noted that, following the sending of this request, the consuming entity ECS generally starts a timer and, if no response is received at the end of a given period, it can possibly retransmit the request.

This request indicates the public identifier of the service requested by the service consuming entity, that corresponds for example to that of the network function NF or the application device that provides the requested service. This unique identifier or URI is defined in a profile of the network function or application device, which is registered in the network, for example by a network function dedicated to registering such profiles.

In 21, at least one operating indicator IND is obtained, for example of a memory M1 of the intermediate entity RP, SCP. It can be for example an indicator of load or traffic, latency, occupancy (saturation) of the physical resources of the network over a given time period of the network RC and/or an indicator of quality of the requests previously processed during an elapsed time period, a rate of requests not validated by the validating entity during the given time period, a rate of error messages generated by the service executing entity for requests that have not been subject to prior validation, etc. These indicators are determined, for example, from measurement data collected in the network by telemetry.

In 22, this indicator or these indicators are used to decide whether the received request REQ is submitted for prior validation or transmitted directly to the concerned entity EES. Advantageously, an identifier (for example, URI) of an entity EVS responsible for validating the requests to execute this service is obtained, as detailed below. At least one decision criterion CRT is taken into account. It can be for example a threshold value of said at least one indicator.

According to a first case, the decision is made to transmit the request REQ to the validating entity EVS responsible for the requested service Si. It is transmitted in 23. To do this, an identifier URI2 of the validating entity EVS has been previously obtained, for example, using configuration rules associating with each service provided by the network RC, or a network function NF or a yet group of network functions of the network RC, the identifier of the corresponding validating entity EVS. As a variant, these configuration rules are grouped in a data table, accessible from the intermediate entity RP, SCP. For example, this information was obtained during a preliminary phase of discovering the service functions available in the network RC and the services they provide.

The validation operations performed by the validating entity EVS on the request REQ are detailed later.

According to a first embodiment of the invention, a response message REP is received in 24. It comprises a validation information message from the validating entity EVS and therefore comprises a validation result RES that can be positive or negative. Based on the validation result, it is decided in 25 to transmit the request REQ in 27 to the service executing entity EES when this validation result is positive, and on the contrary to reject the request REQ otherwise.

Advantageously, when the validation result RES is positive, the response message comprises at least one item of location information of the executing entity EES of the requested service, for example a response that complies with the class “3xx” status code HTTP protocol indicating a redirection, and more precisely of the type “307 Location: URI3”. Such a response comprises, for example, a private identifier of the network function or of the application device that implements the service, possibly supplemented by an identifier of the concerned validating entity EVS, when the intermediate entity is located within this network function.

On the contrary, in case the request REQ is rejected for non-compliance (for example, non-compliant request body format, non-compliant attribute name, non-compliant attribute type, non-compliant attribute value, non-compliant multi-attribute constraint, etc.), the response REP comprises a body and a status code. In the embodiment considered here, it is a response that complies with the HTTP protocol and the status code value is of class “4xx”. The body and the status code comply with specifications of the 3GPP that are set out in one or more OpenAPI documents describing the operations of the service.

In the event of rejection, the response message REP is transmitted to the service consuming entity ECS, that is therefore informed that its request is rejected because it is not valid.

In the event of a positive result, a response message REP′ comprising a service execution report is received in 28 from the executing entity EES and transmitted to the service consuming entity ECS in 29.

It is understood that according to this first embodiment, the intermediate entity RP, SCP is the recipient of all messages sent by the validating entity EVS and the executing entity EES that do not communicate directly. It therefore potentially receives two response messages, namely the response message REP comprising the validation result RES transmitted by the validating entity EVS, and in the event of a positive validation result, the response message REP′ comprising the report on the execution of the service by the executing entity EES.

According to a second embodiment of the invention, only one response message is received by the intermediate entity RP, SCP. In the case where the validating entity EVS has validated the request, only the response message REP′ is received in 28, since the validating entity EVS transmits the request REQ directly to the service executing entity EES in this second embodiment. On the contrary, when the validating entity EVS has rejected the request, a validation information message REP comprising a negative result is received by the intermediate entity RP, SCP in 24. The validation information message REP, comprising the negative result, respectively the response message REP′, is transmitted where applicable by the intermediate entity RP, SCP to the entity ECS in 29, respectively 26.

According to a second case, it is decided not to transmit the request REQ to the validating entity EVS. It is therefore transmitted directly to the executing entity EES in 27. Steps 28 and 29 are identical to those already described.

It is understood that, according to the invention, a request REQ is not necessarily subject to validation, which makes it possible to limit the latency introduced by the implementation of the invention. In this case, an error message can be sent by the executing entity EES when the request REQ comprises non-compliances that make it impossible to execute the requested service or operation. In the embodiment described here, this error message can indicate a class 5xx HTTP status code or a 404 Not Found status code.

In relation to FIGS. 3A to 3C, embodiments of a method for validating a request to execute a service in a communication network according to several embodiments of the invention are now presented in the form of a flowchart. Advantageously, the method is implemented by the validating entity EVS.

In relation to FIG. 3A, a request to execute a service REQ is received in 30 by the validating entity EVS from the intermediate entity RP, SCP. In 31, the information fields making up this request REQ are checked. In particular, in the case of a 5G core network, the check concerns the request body and any associated parameters and headers. Natively, the validating entity EVS has, for example, been designed from a description document of the service programming interface API of the considered service executing entity, for example in OpenAPI format, that describes all the information fields of the request body, as well as any associated parameters and headers. It should be noted that this OpenAPI format also describes the structure of the response messages.

The validating entity EVS thus checks that the request body and any associated parameters and headers comply with those defined in the description document of the service programming interface. At the end of this check, the validating entity EVS provides a result RES (positive in case all the elements of the request REQ that have been checked by the validating entity EVS are compliant, negative in case at least one of these elements is not compliant), that is taken into account in 32 to decide on an action ACT to be triggered.

At this stage, two cases are possible: according to a first embodiment of the invention illustrated by FIG. 3B, the decided action is to send in 321 a response REP to the intermediate entity RP, SCP. When the request REQ has been validated, this response message REP is a validation information message comprising a positive result RES. Optionally, it comprises an item of identification/location information of the service executing entity EES in the network RC and, for example, in the private network of the network function to which it belongs. For example, said item of identification/location information is a universal identifier of type URI (URI3) which is not known to the service consuming entity ECS.

On the contrary, when the request REQ is rejected (i.e. is not validated), the response message REP comprises, in the message body, an error code; it can further comprise a description of the identified errors (in other words, non-compliances). For example, the status code is of type HTTP 400, meaning “Bad Request”. It should be noted that the error response message body complies with the OpenAPI description for any service operation considered.

According to a second embodiment of the invention, illustrated by FIG. 3C, when the request REQ is validated, the action ACT decided is to transmit directly the service execution request REQ in 322 to the executing entity EES (using the identifier URI3). According to this second embodiment, a response message REP′ comprising an execution report sent by the executing entity EES is received in 323 and transmitted in 324 to the intermediate entity RP, SCP. It is understood that according to this second embodiment, the validating entity EVS acts as an intermediary between the intermediate entity RP, SCP and the service executing entity ECS. As a variant, the validating entity EVS is integrated into the intermediate entity RP, SCP.

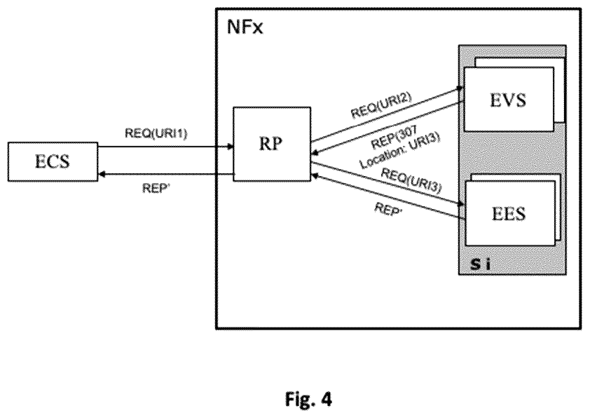

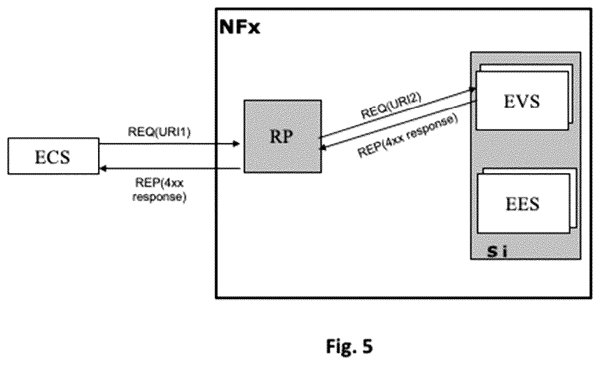

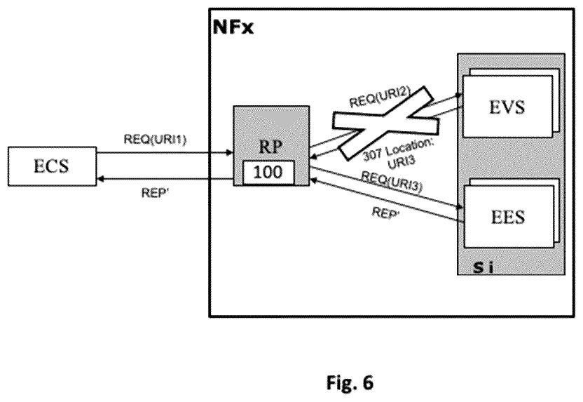

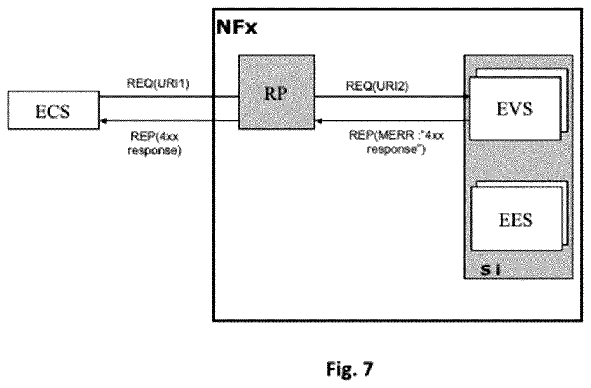

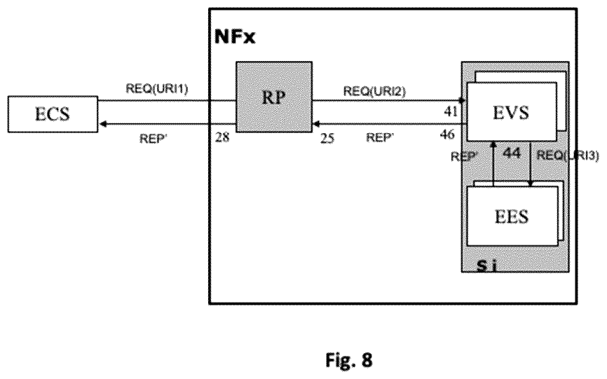

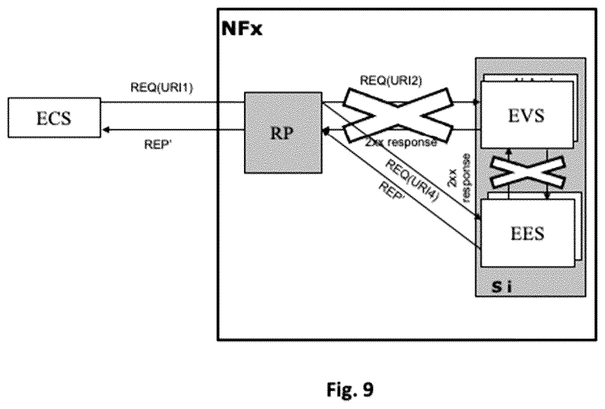

In relation to FIGS. 4 to 12, embodiments of the invention in the case of a 5G core network are now detailed.

As previously mentioned, a 5G core network as specified by the 3GPP consists of various network functions NF, each having a well-defined role. A network function NF is generally responsible for executing several distinct services. A service of a network function is described by the 3GPP as one or more application programming interfaces APIs, themselves specified in a description document that complies with the OpenAPI format. One objective of an API is notably to define the content of the requests to execute a service sent by a service consuming entity and the content of the responses sent by the service executing or producing entity.

It can be for example an API of the REST API type, that is, that complies with a set of architectural constraints defined by REST. It should be noted that APIs of the REST API type are very common nowadays in cloud computing, that consists in using remote servers to process, store and manage data, and apply to any business domain. The invention relates more generally to any application programming interface, for example of the REST API type, designed to execute a service in response to requests from consuming entities whose validity the designer wants to check.

By way of example, the network function NRF (Network function Repository Function) for registering network functions NF, whose role is to provide an up-to-date directory of the state of the network functions NF of a 5G core network and their data defined in a profile (NFProfile) is considered. This profile notably comprises an identifier (URI) that can be used to locate each network function NF in the 5G core network. This identifier generally points to a logical address.

This directory is updated when each function NF is instantiated (registered) and when the characteristics of a function NF are modified, for example when it is resized. The network function NRF thus proposes a service for discovering functions NF. To do this, it implements a service called “Nnrf_NFManagement” for managing network function NF profiles and subscriptions. The operations available for managing a network function NF profile comprise saving, updating, deleting and consulting.

For example, the request to execute a registration operation of a function profile NF is PUT/nf-instances/{nfInstanceID}. It comprises an NFProfile request body. The OpenAPI description of the request for this operation is as follows:

```
put:
  summary: Register a new NF Instance
  operationId: RegisterNFInstance
  tags:
      - NF Instance ID (Document)
      parameters:
      - name: nfInstanceID
      in: path
  required: true
  description: Unique ID of the NF Instance to register
  schema:
        $ref: ‘TS29571_CommonData.yaml#/components/schemas/NfInstanceId’
    name: Content-Encoding
    in: header
    description: Content-Encoding, described in IETF RFC 7231
    schema:
        type: string
    name: Accept-Encoding
    in: header
    description: Accept-Encoding, described in IETF RFC 7231
    schema:
        type: string
    requestBody:
    content:
        application/json:
          schema:
            $ref: ‘#/components/schemas/NFProfile’
        required: true
```

This example does not comprise a query parameter, but it comprises a path parameter in the URI specified by {nfInstanceID}. It should be noted that as a general rule, POST, PUT and DELETE queries do not comprise query parameters, unlike GET queries.

In relation to FIGS. 4 to 9, a network function NFx of the network RC, configured to provide N services, with N an integer greater than or equal to 1, and comprising an intermediate entity RP of the inverted proxy type and executing EES and validating EVS entities of N services is considered. According to these embodiments of the invention, this intermediate entity RP is configured to implement the method for processing a request to execute a service, as previously described. In FIGS. 4 to 9, for the sake of simplicity, only the entities EVS and EES relating to a given service Si are shown, with i an integer between 1 and N. A second rectangle is shown behind each EVS and EES rectangle to indicate that several instances of these entities EVS and EES may have been allocated by an orchestrator of the network RC, based on the requirements, as previously mentioned.

In relation to FIGS. 4 to 7, examples of embodiments of the first embodiment of the invention, according to which the reverse proxy RP is used as an intermediary for all message exchanges, not only between the service consuming entity ECS and the network function NFx, but also between the entities validating EVS and executing EES the service Si, are now described.

In FIG. 4, a request REQ is received by the reverse proxy RP of the network function NFx from a consuming entity ECS of the network, for example another network function of the network RC. This request identifies the service Si by specifying a unique identifier of this service Si in the network RC, for example the URI URI1. This identifier URI1 has been obtained for example by the consuming entity ECS from the service Nnrf_NFmanagement for managing the profiles of the previously mentioned network function NRF.

The request REQ is then transmitted to the validating entity EVS. To do this, the “public” identifier URI1 has been replaced by the reverse proxy RP with a private URI identifier, URI2, associated with the validating entity EVS, that is internal to the network function NFx and therefore not known outside the network function NFx. Upon reception of the request REQ, the validating entity EVS checks it complies with the API specification document of the requested service Si. In the example of FIG. 4, the request REQ is validated. The validating entity EVS returns a response REP to the reverse proxy RP indicating, in a dedicated header, for example the location header, the private identifier URI3 of the executing entity EES of the service Si. This response REP comprises a status code, that corresponds here, in the case of a validated request, to the redirection HTTP code 307. This is a standard redirection HTTP response (with a class 3xx HTTP status code). It should be noted that the entity serving a response of this type indicates the redirection URL in the location header.

The reverse proxy RP transmits the request REQ to the executing entity EES using the identifier URI3. It receives a response REP′ comprising an execution report it then transmits to the service consuming entity ECS.

In reference to FIG. 5, the case of a request REQ that is not validated by the validating entity EVS is now described. The response message REP sent by the validating entity EVS to the reverse proxy RP comprises an error code, that is in the embodiment described here, a class “4xx” HTTP error code. Upon reception, the reverse proxy RP transmits it to the service consuming entity ECS.

In relation to FIG. 6, an example is now described according to which the reverse proxy RP has received the request REQ, but has decided not to submit it for validation by the entity EVS, based on one or more operating indicators representative for example of a state of the network RC, or of the load of the function NFx or yet of a rate of rejection of the requests previously processed for the requested service Si, etc. The request REQ is therefore transmitted directly to the service executing entity EES, whose private identifier URI3 of the network function NFx is obtained by other means, for example based on configuration rules. This request is processed by the service executing entity EES, that returns a response REP′ comprising an execution result to the reverse proxy RP. It is received by the reverse proxy RP, that transmits it to the service consuming entity ECS.

Examples of embodiments of the second embodiment of the invention are now described in relation to FIGS. 7 to 9. As for FIGS. 4 to 6, the method for processing a request to execute a service is implemented by an intermediate entity, for example of the reverse proxy RP type, that is part of the network function NFx.

In reference to FIG. 7, upon reception of the request REQ, the reverse proxy RP transmits it to the validating entity EVS as previously described. The validating entity EVS checks it but does not validate it. It therefore sends a response REP to the reverse proxy RP comprising an error message MERR. In the embodiment described here, this error message uses the class “4xx” HTTP status code. The intermediate entity receives it and transmits it to the consuming entity ECS as previously described.

In reference to FIG. 8, the case where the request REQ has been validated by the entity EVS is now considered. According to this second embodiment, the entity EVS transmits the request REQ directly to the executing entity EES of the requested service Si, using its private identifier URI3. It receives a response REP′ from the executing entity EES, that it transmits to the reverse proxy RP. Upon reception, the intermediate entity RP transmits the response to the service consuming entity ECS.

In relation to FIG. 9, the request REQ is received by the intermediate entity RP that decides, on the basis of at least one decision criterion based on at least one operating indicator, not to submit it for validation by the validating entity EVS. It obtains the identifier URI4 of the service executing entity EES via configuration rules and therefore transmits the request REQ directly to it. The service executing entity EES executes the service and returns it a response REP′ comprising a result of this execution.

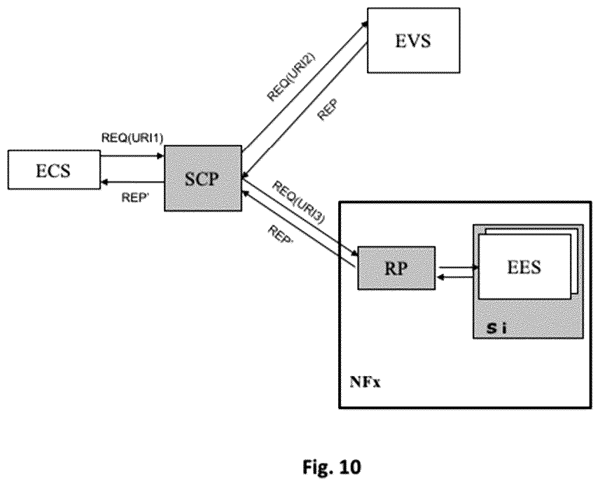

In relation to FIGS. 10 to 12, embodiments according to which the validating entity EVS and the intermediate entity are external to the network function NFx that implements the service Si requested by the service consuming entity ECS and the validating entity EVS are now described. For example, the intermediate entity is an SCP device as previously described. In the case of multi-distributed functions NF and in some deployment models, this SCP device is configured to be a single point of entry for a group of network functions that are registered in the function NRF, including the function NFx. In other words, only the SCP knows the NFx producing the requested service Si.

For example, the validating entity EVS is comprised in another network function (not shown in FIGS. 10 to 12), that can group several distinct service validating entities. It should be noted that in what follows, certain steps will not be described in detail as they are performed similarly to the examples of FIGS. 4 to 9.

In relation to FIG. 10, the SCP device receives the request REQ from the service consuming entity ECS. This request REQ is sent to the public identifier URI1 of the SCP device and comprises an identifier of the desired service Si, for example the name of the API of the service of the network function NFx that implements the service Si (for example, “nsmf-pdusession/v1”). The SCP device transmits it to the concerned validating entity EVS using the identifier URI2 of this entity EVS that it has previously obtained from the identifier of the network function NFx and profile information of the function NFx obtained from the network function NRF. Here, it is not a private identifier, but a routable address in the network RC. The entity EVS checks the received request REQ and sends to the SCP device (URI1) a validation response message REP comprising a positive result (for example, with a status code 307). According to this embodiment, the response REP does not comprise a private identifier URI3 enabling access to the executing entity EES of the requested service Si. For example, the SCP device obtains the identifier URI3 in question from the identifier of the service Si produced by the network function NFx and profile information of the network function providing the service Si, previously obtained from the network function NRF. It transmits the request REQ to the executing entity EES using the identifier URI3. In this example, the request REQ is not received directly by the service executing entity EES, but by an intermediate entity comprised in the network function NFx, for example a reverse proxy device RP as previously described, that is responsible for transmitting the request REQ to the private identifier of the entity EES within the network function NFx. It is understood that in this case, URI3 is the identifier of the reverse proxy device RP of the network function NFx and that the private identifier of the entity EES is not known outside the network function NFx. Upon reception, the entity EES executes the requested service Si and sends a response message REP′ to the device RP, that transmits it to the intermediate entity SCP. Upon reception, the SCP device transmits it to the service consuming entity ECS.

In relation to FIG. 11, a header of the request REQ received by the SCP device is modified by the SCP device to insert the identifier URI3 of the network function NFx (“3gpp-Sbi-Tar-get-apiRoot”=URI3). It should be noted that the SCP is configured to determine this identifier URI3 before the request REQ is actually validated. However, it should also be noted that, according to the current 3GPP standard, the intermediate entity SCP is only configured to subsequently insert it into a response message and not into the request itself as proposed by the present invention.

Here again, it is assumed that the validating entity EVS validates the request REQ. Its response REP, for example a standard redirection HTTP response (with a class 3xx HTTP status code), comprises the previously received private identifier URI3 of the network function NFx, which enables the SCP device to transmit the request REQ directly to this identifier URI. The rest corresponds to what was previously described in relation to FIG. 11. It should be noted that the use of the “3gpp-Sbi-Target-apiRoot” location header just described complies with the 3GPP standard specifications. However, according to the current release of this standard, the intermediate entity SCP is the only recipient of the “3gpp-Sbi-Target-apiRoot” location header contained in a request and the only entity/function of the 5G core network configured to be positioned at a cut-off point of a client-server transaction. The intermediate entity SCP is configured to process this header and then transmit the request to the identifier URI of this header. This header is used to force a request to pass through the intermediate entity SCP.

The present invention proposes to define a new entity/function EVS for validating requests, to insert it at a cut-off point of client/server exchanges and to configure it so that it transmits validated requests directly to the service executing entity EES. To do this, it relies on this location header. As a result, the implementation of the “3gpp-Sbi-Target-apiRoot” header performed in FIG. 11 differs strictly from what is described nowadays in the 3GPP standard.

In relation to FIG. 12, it is now considered, as in the example of FIG. 12, that a header of the request REQ is modified, for example the 3gpp-Sbi-Target-apiRoot header, by the SCP device in order to insert the public identifier URI3 of the network function NFx that implements the requested service Si. The difference is that once the request REQ has been validated by the entity EVS, the latter transmits it directly to the network function NFx using the identifier URI3 it has retrieved from the modified header. As previously described, it is received by the reverse proxy device RP that transmits it to the identifier of the executing entity EES, internal to the network function NFx. Once the service Si is executed, a response REP′ is returned by the entity EES to the reverse proxy RP, that transmits it to the SCP, that in turn transmits it to the service consuming entity ECS. It is understood that this embodiment implies that the validating entity is configured to process the “3gpp-Sbi-Target-api-Root” header, as described in the 3GPP standard for the intermediate entity SCP.

According to yet another embodiment (not shown), the service validating entity EVS could be integrated directly into the SCP.

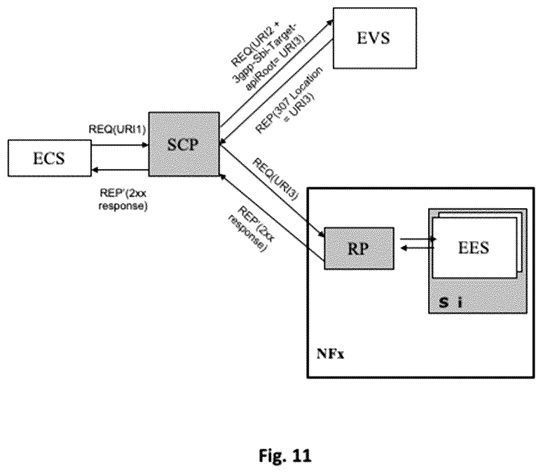

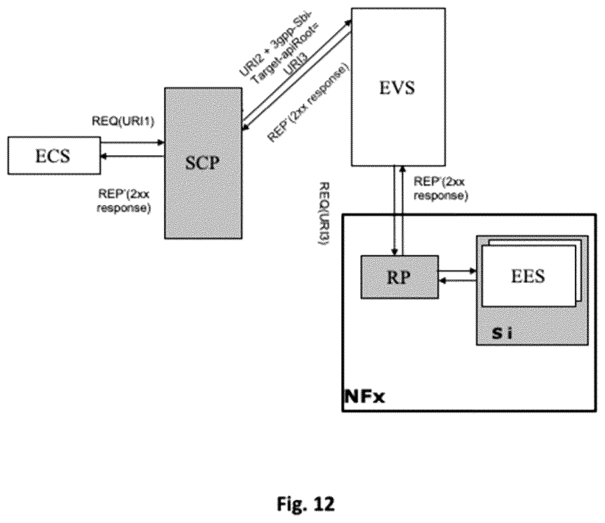

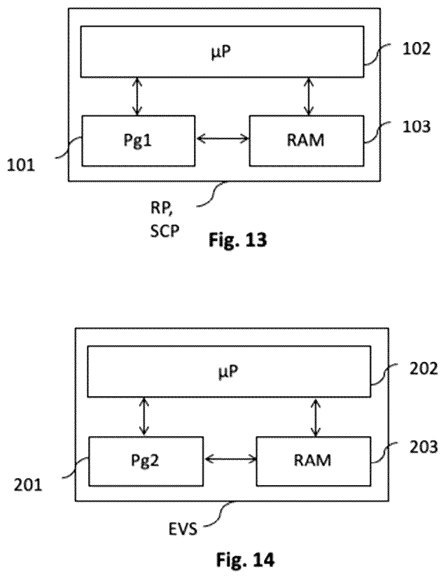

In relation to FIG. 13, an example of the hardware structure of an intermediate entity RP, SCP configured to process a request to execute a service in a communication network, from an entity, referred to as service consuming entity, to an executing entity of said service in said network, said intermediate entity being configured to receive messages from and/or intended for the service executing entity, and comprising a module for transmitting the execution request to a validating entity of said request, distinct from the service executing entity, for validation, and a module for transmitting a response to said request to the service consuming entity, is then presented.

Advantageously, the intermediate entity RP, SCP comprises a module for receiving a validation response message from the validating entity, said message comprising the validation result, and a module for deciding whether or not to transmit the execution request to the service executing entity based on the received validation result. Advantageously, it further comprises a module for transmitting the request to execute the service to the service executing entity, said module being configured to be implemented in response to a positive validation result.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such an intermediate entity RP, SCP comprises a random access memory 103 (a RAM memory, for example), a processing unit 102 equipped for example with a processor and controlled by a computer program Pg1, representative of the above mentioned modules, stored in a read-only memory 101 (a ROM memory or hard disk, for example). At initialisation, the code instructions of the computer program are for example loaded into a random access memory 103 before being executed by the processor of the processing item 102. The random access memory 103 may also contain, for example, information relating to the service validating entity and/or the service executing entity, such as identifiers, enabling access to this entity or these entities, for example obtained during a prior discovery phase. It may also comprise one or more decision criteria relating to triggering the transmission of the received request to execute the service EVS to the service validating entity.

FIG. 13 only shows a particular one of several possible ways of realising the intermediate entity RP, SCP so that it performs the steps of the method for processing a request to execute a service as detailed above, in relation to FIGS. 2 and 3 in its various embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the intermediate entity RP, SCP is realised with a reprogrammable computing machine, the corresponding program (that is the sequence of instructions) can be stored in a removable (such as, for example, an SD card, a USB flash drive, CD-ROM or DVD-ROM) or non-removable storage medium, this storage medium being partially or totally readable by a computer or a processor.

The various embodiments have been described above in relation to an intermediate entity such as a network device of the reverse proxy or SCP device type.

Finally, in relation to FIG. 14, an example of the hardware structure of a validating entity EVS of a request to execute a service in a communication network, said request having been sent by a service consuming entity to a service executing entity, comprising a module for receiving said execution request from an intermediate entity RP, SCP configured to process said execution request, said validating entity being configured to receive messages from and/or intended for the service executing entity, a module for checking a validity of said request, comprising obtaining a validation result and a module for triggering a request processing action based on the validation result obtained.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a validating entity EVS comprises a random access memory 203 (a RAM memory, for example), a processing unit 202 equipped for example with a processor and controlled by a computer program Pg2, representative of the above mentioned modules, stored in a read-only memory 201 (a ROM memory or hard disk, for example). At initialisation, the code instructions of the computer program are for example loaded into a random access memory 203 before being executed by the processor of the processing item 202. The random access memory 203 may also contain, for example, information identifying the executing entity of the requested service and/or the intermediate entity RP, SCP.

FIG. 14 only shows a particular one of several possible ways of realising the validating EVS so that it performs the steps of the method for validating a request to execute a service as detailed above, in relation to FIGS. 4 to 12 in its various embodiments.

Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the validating entity EVS is realised with a reprogrammable computing machine, the corresponding program (that is the sequence of instructions) can be stored in a removable (such as, for example, an SD card, a USB flash drive, CD-ROM or DVD-ROM) or non-removable storage medium, this storage medium being partially or totally readable by a computer or a processor.

The embodiments just described can be combined.

1. A processing method comprising:
processing a request to execute a service in a communication network, from a service consuming entity to an executing entity of said service, wherein the processing is implemented at an intermediate entity configured to receive messages from the service consuming entity intended for the service executing entity or from the service executing entity intended for the service consuming entity, and comprises:
receiving said request to execute the service from the service consuming entity; and
deciding whether or not to transmit for validation the request to execute the service to a validating entity of said request, distinct from the service executing entity, before transmitting said request to the service executing entity.

2. The processing method according to claim 1, wherein the processing comprises:
transmitting said request to execute the service to the service validating entity;
receiving at least one response message from among a validation information message and an execution report message; and
transmitting the received response message to the concerned entity from among the service consuming entity and the service executing entity, based on the received response message.

3. The processing method according to claim 2, wherein the at least one received response message comprises a validation information message from the validating entity comprising a validation result, the validation information message is transmitted to the service consuming entity when the validation result is negative, and the request to execute the service is transmitted to the service executing entity when the validation result is positive.

4. The processing method according to claim 3, wherein the processing comprises, in response to a positive validation result, obtaining by the intermediate entity an identifier of the service executing entity, and the request to execute the service is transmitted to the service executing entity using said obtained identifier.

5. The processing method according to claim 1, wherein said at least one received response message comprises a service execution report message sent by the service executing entity and the service execution report message is transmitted to the service consuming entity.

6. The processing method according to claim 1, wherein the decision-whether or not to transmit said request to the service validating entity is made based on at least one given decision criterion-relating to at least one network operation indicator and/or at least one type of request to execute the service.

7. A validation method comprising:
validating a request to execute a service in a communication network, said request having been sent by an entity referred to as a service consuming entity of said network to a service executing entity, the validating being implemented at a service validating entity distinct from said executing entity and comprising:
receiving said request to execute the service from an intermediate entity configured to receive messages to or from the service executing entity;
checking a validity of said request to execute the service, comprising obtaining a validation result; and
executing at least one action based on the validation result obtained.

8. The validation method according to claim 7, wherein said at least one action comprises transmitting a validation information message comprising the validation result to the intermediate entity.

9. The validation method according to claim 7, wherein, when the validation result is positive, said at least one action comprises transmitting-said request to execute the service to the service executing entity.

10. The validation method according to claim 9, wherein said at least one action further comprises receiving a response message from the service executing entity comprising a service execution report and transmitting said response message to the intermediate entity.

11. An intermediate entity of a communication network, the intermediate entity comprising:
at least one processor; and
at least one non-transitory computer readable medium comprising instructions stored thereon which when executed by the at least one processor configure the intermediate entity to receive messages from a service consuming entity, intended for a service executing entity of said service and to receive messages from the service executing entity intended for the service consuming entity, said instructions further configuring the intermediate entity to implement:
receiving a request to execute the service from the service consuming entity; and
deciding whether or not to transmit for validation the request to execute the service to a validating entity of said request, distinct from the service executing entity, before transmitting said request to the service executing entity.

12. A validation entity of a request to execute a service in a communication network, said request having been sent by a service consuming entity to a service executing entity, wherein the validation entity comprises:
at least one processor; and
at least one non-transitory computer readable medium comprising instructions stored thereon which when executed by the at least one processor configure the validation entity to implement:
receiving said execution request, said request having been transmitted to the validating entity by an intermediate entity configured to receive messages from and/or intended for the service executing entity;
checking a validity of said request; and
transmitting a response message to the intermediate entity comprising at least one validation result.

13. (canceled)

14. A non-transitory computer readable medium comprising program code instructions stored thereon for implementing the processing method according to claim 1, when the instructions are executed by a processor of the intermediate entity.

15. A non-transitory computer readable medium comprising program code instructions stored thereon for implementing the processing method according to claim 7, when the instructions are executed by a processor of the service validating entity.
